(19) United States
(12) Patent Application Publication
(10) Pub. No.: US 2015/0220874 A1
(43) Pub. Date: Aug. 6, 2015

(54) Systems, Devices, and Methods for Determining an Optimal Inventory Level for an Item with Disproportionately Dispersed Sales

(71) Applicant: Homer TLC, Inc., Wilmington, DE (US)

(72) Inventors: Robert Woolsey, Atlanta, GA (US); Nirjhar Raina, Smyrna, GA (US)

(73) Assignee: Homer TLC, Inc., Wilmington, DE (US)

(21) Appl. No.: 14/171,571

(22) Filed: Feb. 3, 2014

(51) Int. Cl. G06Q 10/08

(52) U.S. Cl. CPC G06Q 10/087

(57) ABSTRACT

This disclosure includes various methods, devices, and systems for automatically identifying products for which sales were disproportionately dispersed and optimizing the inventory levels of such products.

### FIELD OF INVENTION

This disclosure relates generally to methods, devices, and systems for optimization of product inventory levels and, more particularly, but not by way of limitation, to methods, devices, and systems for identifying one or more products for which sales were disproportionately dispersed and optimizing the inventory levels of such products.

### BACKGROUND

Inventory management is imperative in retail operations. Retailers must balance the need to have a product in-stock for customers with the desire to maintain as little stock as possible. Inventory and replenishment levels are conventionally determined using a variety of metrics, such as sales forecasts, seasonality, and service levels percentages.

A job lot quantity (JLQ) refers to an amount of product necessary to complete a customer's project. A challenge with ensuring that a JLQ is in stock is that some products may sell relatively infrequently but, when they do sell, might sell in large quantities due to the nature of the project (e.g., the for a kitchen remodel). Additionally, the standard job size for a product can differ significantly between different stores across the U.S. and elsewhere, due, for example, to differences in lot or home size. Because of this sales behavior, which can also vary by a product's seasonality, conventional metrics, such as average weekly or monthly unit sales, may not be helpful in identifying such JLQ sales.

### SUMMARY

This disclosure includes embodiments of systems, devices, and methods for identifying one or more products for which sales were disproportionately dispersed and optimizing the inventory levels of such products. In some embodiments, a dispersion metric, such as one based on the determination of a Gini coefficient, may be used to measure the dispersion inequality of sales for multiple products to identify those products that exhibit JLQ-like behavior (e.g., products that may sell relatively infrequently, but when they do sell, may sell in large quantities).

The sales history for a product exhibiting JLQ behavior may be further analyzed to determine optimal inventory levels for the product. For example, when daily sales information for a year are available, the daily sales may be separated into two or more groups using K-means clustering to separate the subset of daily sales that constitute a disproportionate amount of the total sales history from the rest of the daily sales (to separate the JLQ sales values from the rest of the sales values). In some embodiments, an initial JLQ value may be set to the mean sales value of the subset of daily sales that constitute a disproportionate amount of the total sales history (e.g., the cluster of sales values with the greatest mean), and the annual frequency for the JLQ product may be set to the number of daily sales values (N) in the cluster of sales values with the greatest mean (e.g., the subset of daily sales that constitute a disproportionate amount of the total sales history).

In some embodiments, the desired inventory level may be a monthly inventory target, in which case the monthly frequency can be deduced from the annual frequency using, for example, the product's seasonal profile. The frequency or rate a store expects to sell a job is generally directly proportional to that item's seasonal factors. To account for seasonal variations in the product's sales, the annual frequency may be multiplied by a predetermined seasonal factor that is specific to the month of interest. In some embodiments, multiple probabilities may be calculated based on the adjusted annual frequency to specify the probabilities of a discrete number of JLQ product sales occurring during the month of interest. Based on the calculated probabilities and a desired percentage of possible JLQ product sales to support, a scaling factor may be determined that scales the product's inventory level to meet the desired coverage. In some embodiments, the desired inventory level for the month of interest may be set to be equal to the initial JLQ value scaled by the determined scaling factor.

Some embodiments of computerized methods (e.g., of identifying products for which sales were disproportionately dispersed and optimizing the inventory levels of such products) comprise: calculating a dispersion inequality value of sales for a product; determining whether the dispersion inequality value exceeds a threshold; determining a first quantity value and a first frequency for the product based, at least in part, on sales values of the product within a subset of time units of a time period; and determining an inventory quantity value for the product based, at least in part, on the determined first quantity value and the determined first frequency for the product. These steps may be accomplished using one or more computers that operate under the control of software, firmware, hardware, or any combination of these. More specifically, these steps may be accomplished using one or more processors, which may be hardwired, controlled via software, or a combination of both. This can also be true for any one or more of the steps in this disclosure and in any one or more of the claims.

Some embodiments of systems comprise: a memory; and a processor coupled to the memory, the processor configured to: calculate a dispersion inequality value of sales for a product; determine whether the dispersion inequality value exceeds a threshold; determine a first quantity value and a first frequency for the product based, at least in part, on sales values of the product within a subset of time units of a time period; and determine an inventory quantity value for the product based, at least in part, on the determined first quantity value and the determined first frequency for the product.

Some embodiments of computer program products comprise: a non-transitory computer-readable medium comprising code to perform the steps of: calculating a dispersion inequality value of sales for a product; determining whether the dispersion inequality value exceeds a threshold; determining a first quantity value and a first frequency for the product based, at least in part, on sales values of the product within a subset of time units of a time period; and determining an inventory quantity value for the product based, at least in part, on the determined first quantity value and the determined first frequency for the product.

Some embodiments of computerized methods (e.g., of identifying products for which sales were disproportionately dispersed and optimizing the inventory levels of such products) comprise: calculating a dispersion inequality value of sales for one or more products, wherein each of the one or more products is associated with one dispersion inequality value; identifying a product from the one or more products for which sales for the identified product were disproportionately dispersed over (or among) a time period comprising a plurality of time units (e.g., wherein sales for the product are disproportionately dispersed when the dispersion inequality value associated with the product exceeds a threshold); determining a first quantity value and a first frequency for the identified product based, at least in part, on sales values of the identified product within a subset of time units of the time period; and determining an inventory quantity value for the identified product based, at least in part, on the determined first quantity value and the determined first frequency for the product. In some embodiments, the dispersion inequality value comprises a Gini coefficient. In other embodiments, the dispersion inequality value provides an indication of the unequal dispersion of sales over the time period. In still other embodiments, the identified product is the product associated with the highest calculated dispersion inequality value that exceeds the threshold.

In some embodiments, calculating the dispersion inequality value for at least one product of the one or more products comprises: ordering the plurality of time units in ascending order according to sales values, wherein the first time unit is associated with a smallest sales value for the at least one product and the last time unit is associated with a largest sales value for the at least one product; and calculating the dispersion inequality value based, at least in part, on the ordered plurality of time units. Some embodiments further comprise subtracting the average sales value per time unit for the at least one product from each of the ordered plurality of time units to obtain an adjusted sales value for each of the ordered plurality of time units, wherein the calculation of the dispersion inequality value is based, at least in part, on the adjusted sales value for each of the ordered plurality of time units.

Some embodiments further comprise: clustering the plurality of time units into one of two clusters, wherein a mean sales value per time unit for a first cluster of time units is greater than the mean sales values per time unit for a second cluster of time units. In some embodiments, the subset of time units comprises the first cluster of time units, the first quantity value for the product comprises the mean sales value per time unit for the first cluster of time units, and the first frequency for the product comprises the number of time units in the first cluster of time units. In some embodiments, clustering comprises k-means clustering, wherein k is equal to two.

Some embodiments further comprise: determining a second frequency for the product, wherein the second frequency is a frequency associated with a portion of the time period; multiplying the first frequency by a seasonal factor associated with the portion of the time period to obtain an adjusted first frequency; determining a probability of having, within the portion of the time period, zero, one, or more time units with disproportionate sales values based, at least in part, on the adjusted first frequency, wherein each number of time units is associated with one probability; determining a scaling factor based, at least in part, on the determined probabilities and a percentage of sales for the product to support; and multiplying the first quantity value by the determined scaling factor to obtain the inventory quantity value for the product for the portion of the time period. In some embodiments, the probabilities are determined using a binomial distribution. In some embodiments, the time period comprises a year, the time unit comprises a day, and the portion of the time period comprises 4 weeks.

Some embodiments of systems comprise: a memory; and a processor coupled to the memory, the processor configured to: calculate a dispersion inequality value of sales for one or more products, wherein each of the one or more products is associated with one dispersion inequality value; identify a product from the one or more products for which sales for the identified product were disproportionately dispersed over a time period comprising a plurality of time units (wherein, e.g., sales for the product are disproportionately dispersed when the dispersion inequality value associated with the product exceeds a threshold); determine a first quantity value and a first frequency for the identified product based, at least in part, on sales value of the identified product within a subset of time units of the time period; and determine an inventory quantity value for the identified product based, at least in part, on the determined first quantity value and the determined first frequency for the product.

Some embodiments of computer program products comprise: a non-transitory computer-readable medium comprising code to perform the steps of: calculating a dispersion inequality value of sales for one or more products, wherein each of the one or more products is associated with one dispersion inequality value; identifying a product from the one or more products for which sales for the identified product were disproportionately dispersed over a time period comprising a plurality of time units (wherein, e.g., sales for the product are disproportionately dispersed when the dispersion inequality value associated with the product exceeds a threshold); determining a first quantity value and a first frequency for the identified product based, at least in part, on sales values of the identified product within a subset of time units of the time period; and determining an inventory quantity value for the identified product based, at least in part, on the determined first quantity value and the determined first frequency for the product.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” and “about” may be substituted with “within [a percentage] of” what is specified.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a system or device (such as a computer program product) that “comprises,” “has,” “includes,” or “contains” one or more elements possesses those one or more elements, but is not limited to possessing only those elements. Likewise, a method that “comprises,” “has,” “includes,” or “contains” one or more steps possesses those one or more steps, but is not limited to possessing only those one or more steps.

Any embodiment of any of the devices, systems, and methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Details associated with the embodiments described above and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1 depicts a schematic block diagram illustrating a computer network according to one embodiment of the disclosure.

FIG. 2 depicts a schematic block diagram illustrating system according to one embodiment of the disclosure.

FIG. 3 depicts a schematic block diagram illustrating a computer system according to one embodiment of the disclosure.

FIG. 4 depicts a flow chart illustrating a method of determining an inventory level for a product according to one embodiment of the disclosure.

FIG. 5a depicts a plot of ordered sales days for calculating a dispersion inequality value for a product according to one embodiment of the disclosure.

FIG. 5b depicts a plot of the unordered sales days used to create the plot of FIG. 5a according to one embodiment of the disclosure.

FIG. 6a depicts another plot of ordered sales days for calculating a dispersion inequality value for a product according to one embodiment of the disclosure.

FIG. 6b depicts a plot of the unordered sales days used to create the plot of FIG. 6a according to one embodiment of the disclosure.

FIG. 7 depicts an adjustment of daily sales values to enhance the dispersion exhibited in a sales history according to one embodiment of the disclosure.

FIGS. 8a-8b depict plots illustrating the use of k-means clustering to determine JLQ values and frequencies for different products according to embodiments of the disclosure.

FIGS. 9a-9b depict plots illustrating the removal of outliers from a sales history according to embodiments of the disclosure.

FIG. 10 depicts a table illustrating the determination of a service level percentage according to one embodiment of the disclosure.

### DESCRIPTION OF ILLUSTRATIVE EMBODIMENTS

Various features and advantageous details are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

Certain units described in this specification have been labeled as modules in order to more particularly emphasize their implementation independence. A module is “[a] self-contained hardware or software component that interacts with a larger system.” Alan Freedman, “The Computer Glossary” 268 (8th ed. 1998). A module comprises a machine- or machines-executable instructions. For example, a module may be implemented as a hardware circuit comprising custom VLSI circuits or gate arrays, off-the-shelf semiconductors such as logic chips, transistors, or other discrete components, all of which are non-transitory. A module may also be implemented in programmable hardware devices such as field programmable gate arrays, programmable array logic, programmable logic devices or the like, all of which are non-transitory.

Modules may also include software-defined units or instructions stored on non-transitory media, that when executed by a processing machine or device, transform data stored on a data storage device from a first state to a second state. An identified module of executable code may, for instance, comprise one or more physical or logical blocks of computer instructions that may be organized as an object, procedure, or function. Nevertheless, the executables of an identified module need not be physically located together, but may comprise disparate instructions stored on non-transitory media in different locations that, when joined logically together, comprise the module, and when executed by the processor, achieve the stated data transformation. A module of executable code may be a single instruction, or many instructions, and may even be distributed over several different code segments, among different programs, and/or across several non-transitory memory devices. Similarly, operational data may be identified and illustrated herein within modules, and may be stored on any suitable non-transitory media, embodied in any suitable form, and organized within any suitable type of data structure. The operational data may be collected as a single data set on non-transitory media, or may be distributed over different locations over different non-transitory media.

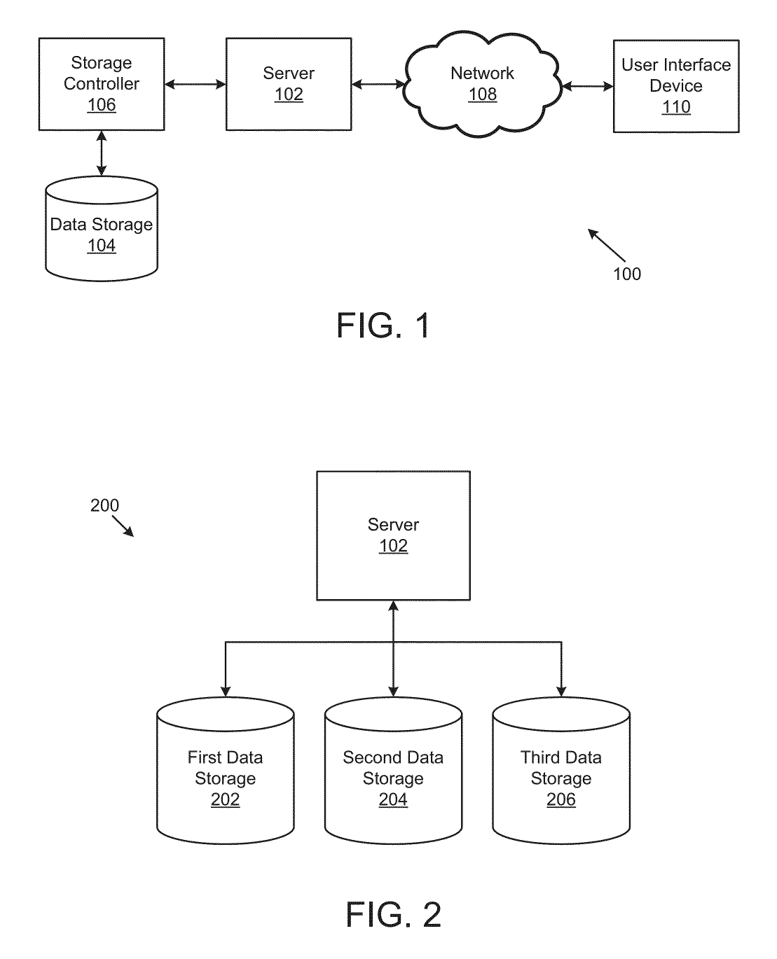

FIG. 1 illustrates one embodiment of a system 100 for identifying products for which sales were disproportionately dispersed and optimizing the inventory levels of such products. References to sales that “are” disproportionately dispersed should be understood to apply to sales that have already taken place, and the present tense of the passive verb “are” signifies a recognition (which may be in the present) of the disproportionate dispersion of those past sales, though the term “were” may also be used and would indicate the fact that the past sales were, in fact, disproportionately dispersed, regardless of when that fact is recognized. System 100 may include a server 102, a data storage device 104, a network 108, and a user interface device 110. In some embodiments, server 102 may include storage device 104 (a server housing or enclosure may house storage device 104). In some embodiments, system 100 may include a storage controller 106, and/or a storage server configured to manage data communications between data storage device 104 and server 102, and/or other components in communication with network 108. In some embodiments, storage controller 106 may be coupled to network 108 (e.g., such that server 102 communicates or is configured to communicate with storage controller 106 and/or storage device 104 via network 108). In a general embodiment, system 100 may be configured to store data (e.g., sales information, user input, seasonal factors) from which products for which sales were disproportionately dispersed can be identified and from which optimal inventory levels for the products may be determined. In some embodiments, system 100 is configured to permit multiple uses and/or functions to or with the data.

In some embodiments, server 102 is configured to access data stored in data storage device(s) 104 via a Storage Area Network (SAN) connection, a Local Area Network (LAN), a data bus, or the like. Data storage device 104 may include a hard disk, including hard disks arranged in an Redundant Array of Independent Disks (RAID) array, a tape storage drive comprising a magnetic tape data storage device, an optical storage device, or the like. In one embodiment, data storage device 104 stores product data including, for example, custom data, as described in more detail below. In some embodiments, server 102 and/or storage device(s) 104 are configured to create a back-up (full and/or partial back-up) of the data of system 100, such as, for example, periodically and/or responsive to an instruction from a system administrator to back-up data on the system.

In some embodiments, user-interface device 110 is referred to broadly and comprises a suitable processor-based device such as, for example, a desktop computer, a laptop computer, a Personal Digital Assistant (PDA), and/or a mobile communication or organizer device (e.g., a cellular phone, smartphone, etc.) having access to the network 108. In some embodiments, user interface device 110 can be configured to access the Internet to access a web application or web service hosted by server 102 and thereby provide a user interface for enabling a user to enter or receive information (e.g., from server 102). For example, in some embodiments, user interface device 110 can be configured to: receive from a user (e.g., via user-input device, such as a keyboard, mouse, touchscreen, and/or the like); prompt a user for (e.g., server 102 can be configured to instruct user-interface device 110 to prompt a user for); and/or transmit to server 102 (e.g., via network 108), user inputs, such as a threshold specifying a minimum dispersion inequality value that indicates a product had sales that were disproportionately dispersed over (or among) a time period or a desired percentage of sales for the product to support.

Network 108 may facilitate communications of data between server 102 and user interface device 110. Network 108 may include any type of communications network including, but not limited to, a direct PC to PC connection, a LAN, a wide area network (WAN), a modem to modem connection, the Internet, a combination of the above, or any other communications network now known or later developed within the networking arts which permits two or more computers to communicate, one with another.

FIG. 2 illustrates one embodiment of a data management system 200 configured to store and manage data for identifying products for which sales were disproportionately dispersed and optimizing the inventory levels of such products. In one embodiment, the system 200 may include a server 102. The server 102 may be coupled to a data bus that may, for example, communicate with one or more data storage devices. In one embodiment, the system 200 may also include a first data storage device 202, a second data storage device 204, and/or a third data storage device 206. In further embodiments, the system 200 may include additional data storage devices (not shown). In such an embodiment, each data storage device 202-206 may host a separate database of products including, for example, product type (e.g., hammer), sub-type (e.g., tack), product attributes (e.g., head weight), and/or other data related to the product(s), such as sales histories or seasonal factors for each of the products. In some embodiments, storage devices 202-206 may be arranged in a RAID configuration for storing redundant copies of a database or databases (e.g., through synchronous or asynchronous redundancy updates).

In various embodiments, server 102 may communicate with data storage devices 204-210 over a data bus (illustrated by arrows between server 102 and storage devices 202-206). In such embodiments, the data bus may comprise a SAN, a LAN, or the like. The communication infrastructure may include Ethernet, Fibre-Channel Arbitrated Loop (FC-AL), Small Computer System Interface (SCSI), and/or other similar data communication schemes associated with data storage and communication. For example, server 102 may communicate indirectly with data storage devices 202-206 (e.g., via a storage server or storage controller 106).

Server 102 may host one or more software applications (e.g., web- and/or Internet-accessible software applications) configured for (e.g., network-based) access to and/or modification of the data and/or executables (e.g., for implementing the methods) described in this disclosure. The software application may further include modules configured to interface with data storage devices 202-206, network 108, a user (e.g., via a user-interface device 110), and/or the like. In a further embodiment, server 102 may host an engine, application plug-in, or application programming interface (API). In another embodiment, server 102 may host a web service and/or other web accessible software application.

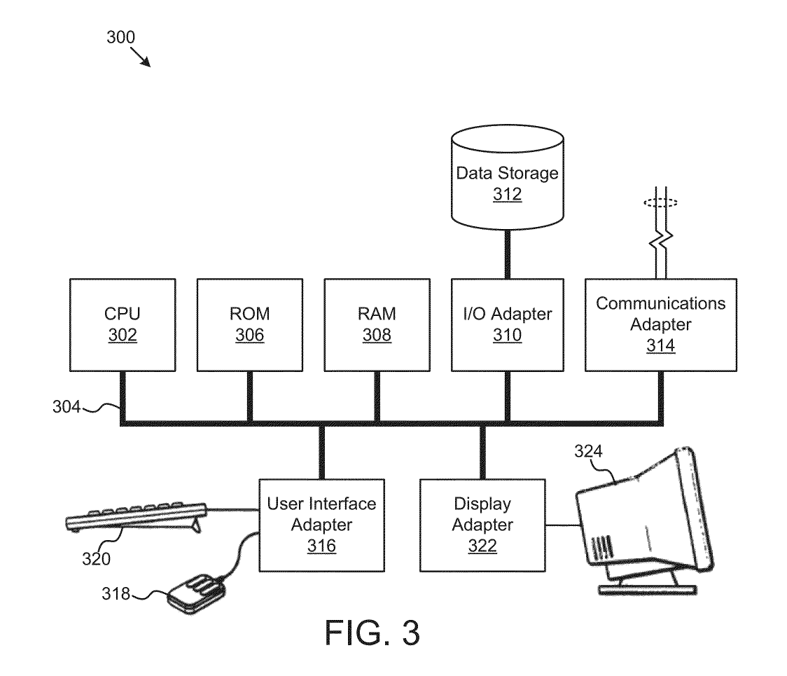

FIG. 3 illustrates a computer system 300 adapted according to certain embodiments of server 102 and/or user interface device 110. Central processing unit (CPU) 302 is coupled to system bus 304. CPU 302 may be a general purpose CPU or microprocessor. The present embodiments are not restricted by the architecture of CPU 302, as long as CPU 302 supports the modules, configurations, and/or operations as described herein. CPU 302 may execute the various logical instructions of the present embodiments. For example, CPU 302 may execute machine-level instructions according to the exemplary operations described below.

Computer system 300 also may include Random Access Memory (RAM) 308, which may be SRAM, DRAM, SDRAM, or the like. Computer system 300 may utilize RAM 308 to store the various data structures used by a software application configured for identifying products for which sales were disproportionately dispersed and optimizing the inventory levels of such products. Computer system 300 may also include Read Only Memory (ROM) 306 which may be PROM, EPROM, EEPROM, optical storage, or the like. ROM 306 may store configuration information for booting computer system 300. RAM 308 and ROM 306 may also store user and/or system 100 data.

Computer system 300 may also include an input/output (I/O) adapter 310, a communications adapter 314, a user interface adapter 316, and a display adapter 322. I/O adapter 310, communications adapter 314, and/or user interface adapter 316 may, in some embodiments, enable a user to interact with computer system 300 (e.g., to input information to, for example, access, identify, and/or modify data associated with products). In a further embodiment, display adapter 322 may display a graphical user interface associated with a software or web-based application for accessing the system and/or implementing the methods described in this disclosure.

I/O adapter 310 may connect one or more storage devices 312, such as one or more of a hard drive, a Compact Disk (CD) drive, a floppy disk drive, and a tape drive, to the computer system 300. Communications adapter 314 may be adapted to couple computer system 300 to network 108, which may, for example, be one or more of a LAN, WAN, and/or the Internet. User interface adapter 316 couples user input devices, such as a keyboard 320 and a pointing device 318, to computer system 300. Display adapter 322 may be driven by CPU 302 to control the display on display device 324.

The present embodiments are not limited to the architecture of system 300. Rather, computer system 300 is provided as an example of one type of computing device that may be configured to perform the functions of a server 102 and/or user interface device 110. For example, any suitable processor-based device may be utilized including without limitation, PDAs, computer game consoles, smart phones, and multi-processor servers. Moreover, the present embodiments may be implemented on application specific integrated circuits (ASIC) or very large scale integrated (VLSI) circuits. In fact, persons of ordinary skill in the art may utilize any number of suitable structures capable of executing logical operations according to the described embodiments.

In view of the exemplary systems shown and described herein, methodologies that may be implemented in accordance with the disclosed subject matter will be better appreciated with reference to various functional block diagrams. While, for purposes of simplicity of explanation, methodologies are shown and described as a series of acts/blocks, it will be understood and appreciated that the claimed subject matter is not limited by the number or order of blocks, as some blocks may occur in different orders and/or at substantially the same time with other blocks from what is depicted and described. Moreover, not all illustrated blocks may be required to implement all of the described methodologies. It will also be appreciated that the functionality associated with the blocks may be implemented by the disclosed systems.

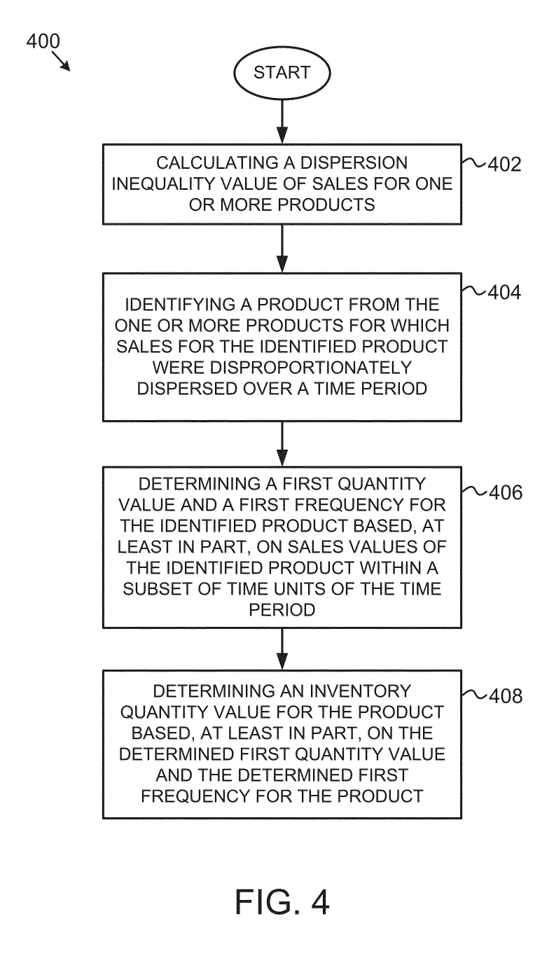

FIG. 4 depicts a flow chart illustrating a method of determining an inventory level for a product according to one embodiment of the disclosure. Embodiments of method 400 may be implemented with the systems described above with respect to FIGS. 1-3. For example, embodiments of method 400 may be implemented by system 100. In general, embodiments of method 400 may be implemented by other similar systems without deviating from this disclosure so long as the systems, whether directly or indirectly, support the operations described.

Specifically, method 400 of the illustrated embodiments includes, at block 402, calculating a dispersion inequality value of sales for one or more products. According to one embodiment, the dispersion inequality value provides an indication of the unequal dispersion of product sales over a time period. In some embodiments, the dispersion inequality value may be a Gini coefficient, although one of ordinary skill in the art will appreciate that other dispersion metrics may be used to determine other dispersion inequality values without departing from this disclosure.

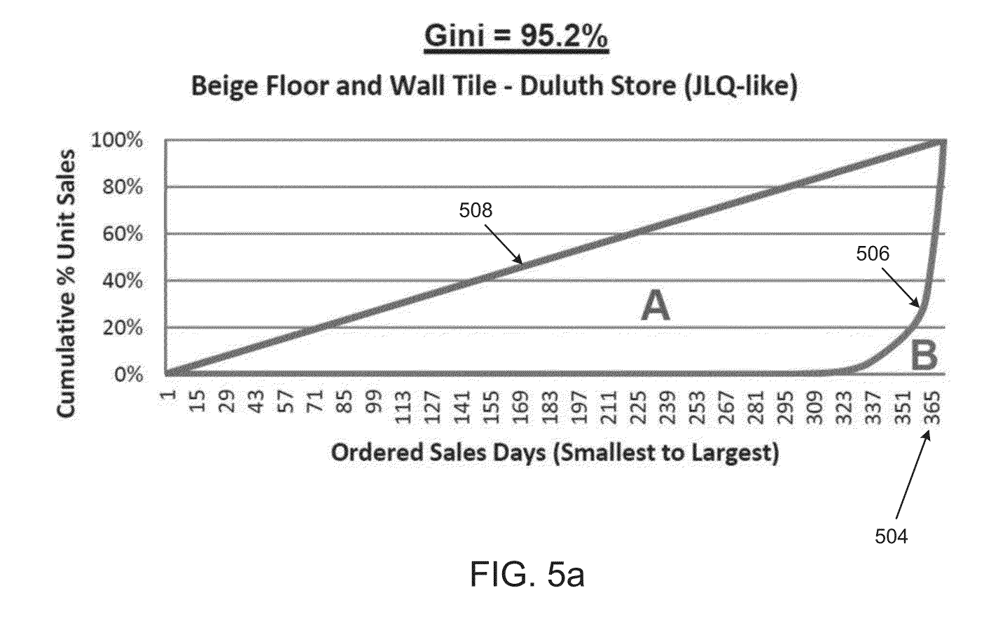

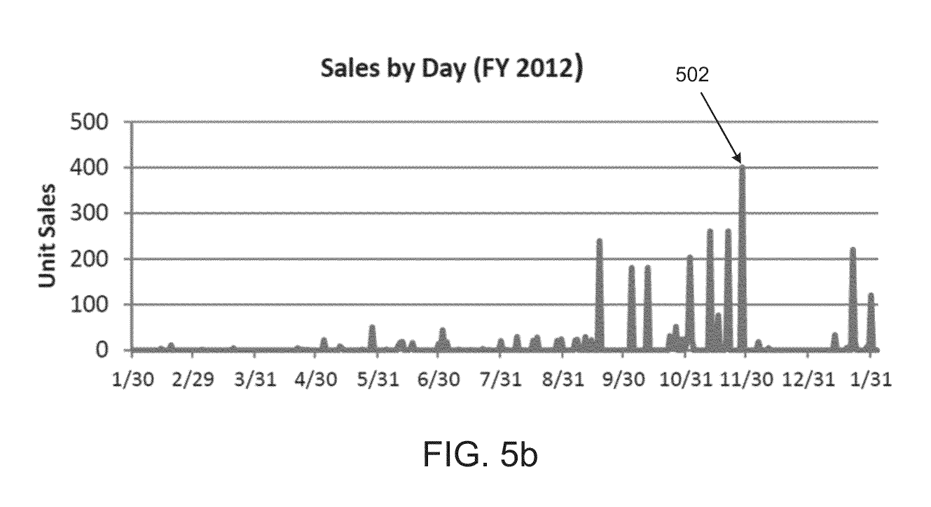

As one example of using a Gini coefficient to indicate the dispersion inequality of sales for a product, FIG. 5a depicts a plot of ordered sales days for calculating a dispersion inequality value, such as the Gini coefficient, for a product, and FIG. 5b depicts a plot of the unordered sales days used to create the plot of FIG. 5a according to one embodiment of the disclosure. According to the embodiment illustrated in FIGS. 5a-5b, the sales history time period is a calendar year and the time units for which sales are provided are days. It is apparent from FIG. 5b that although for the majority of days the unit sales were relatively low or constant, there were a few days where the number of units sold deviated significantly from the norm. As a result, those few days where the number of units sold deviated significantly from the norm may constitute a disproportionately high percentage of the total annual sales.

The Gini coefficient may be used to quantify the disproportionality of the sales history illustrated in FIG. 5b. First, the sales days may be ordered in ascending order according to number of units sold. That is, the first day in the ordered sales days may be the day on which the smallest number of units were sold for the product. The last day may be the day on which the largest number of units were sold for the product. For example, the day from the unordered sales days illustrated in FIG. 5b that contains data point 502 may be the last day 504 in the ordered sales days illustrated in FIG. 5a. With the days ordered as illustrated in FIG. 5a, the cumulative percentage of the total unit sales based on the ordered sales days may be plotted, as illustrated with line 506. Line 508 plots a line of equality, showing what it would look like if the total unit sales for the year were dispersed such that the same number of units were sold every day of the year. Based on the ordered daily sales illustrated in FIG. 5a, the Gini coefficient may be calculated to be equal to the area between the line of equality 508 and line 506 (i.e., area A) divided by the area under line 508 (i.e., area A+area B). That is, the Gini coefficient=area A/(area A+area B). Because area A is significantly larger than the size of area B, the Gini coefficient is large. For example, in the embodiment of FIGS. 5a-5b, the Gini coefficient was determined to be 95.2%. According to the embodiment of FIGS. 5a-5b, the higher the percentage of units sold in a small number of days leads to a smaller area B, resulting in a larger Gini coefficient. Similarly, the smaller the number of days on which a high percentage units are sold leads to a smaller area B, also resulting in a larger Gini coefficient.

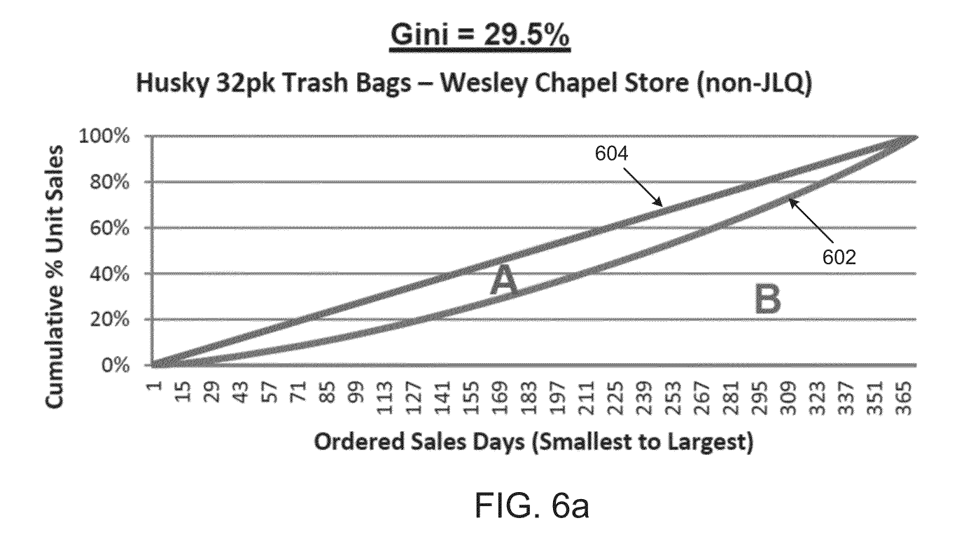

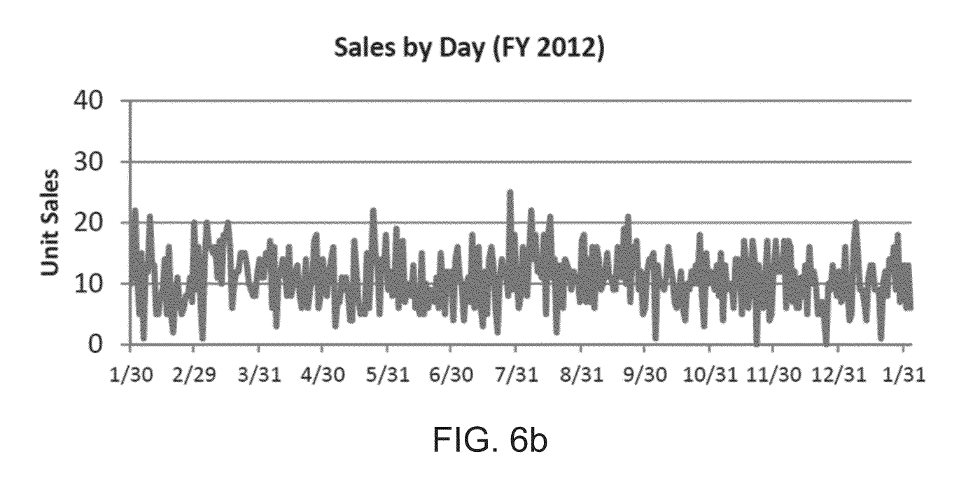

FIG. 6a depicts another plot of ordered sales days for calculating a dispersion inequality value, such as the Gini coefficient, for a product, and FIG. 6b depicts a plot of the unordered sales days used to create the plot of FIG. 6a according to one embodiment of the disclosure. According to the embodiment of FIG. 6b, the number of units sold each day may not vary significantly for the recorded year, which may indicate that there are no days in the yearly sales history that constituted a disproportionate percentage of total yearly sales. For example, line 602 plots the cumulative percentage of the total unit sales based on the ordered sales days of the sales days illustrated in FIG. 6b. Line 604 plots the line of equality, showing what it would look like if the total unit sales for the year were dispersed such that the same number of units were sold every day of the year. Because the difference between the size of area A and the size of area B is small, the Gini coefficient is also small. For example, in the embodiment of FIGS. 6a-6b, the Gini coefficient was determined to be 29.5%.

A Gini coefficient may be calculated for a multitude of products at a specific store where the products are sold, thereby representing the amount of dispersion in the sales for each of the products at the store. That is, each product at the store may be associated with one dispersion inequality value, such as one Gini coefficient. In other embodiments, the Gini coefficient may take into account the total sales nationwide for a product by using nationwide sales histories for the product. The Gini coefficient calculated for a product based on nationwide sales may indicate the dispersion in the sales for the product nationwide. In general, a dispersion inequality value, such as a Gini coefficient, may be calculated for a product based on a number of sales histories, such as daily sales histories at a specific store, monthly sales histories at a specific store, daily sales histories in a city, weekly sales histories nationwide, etc.

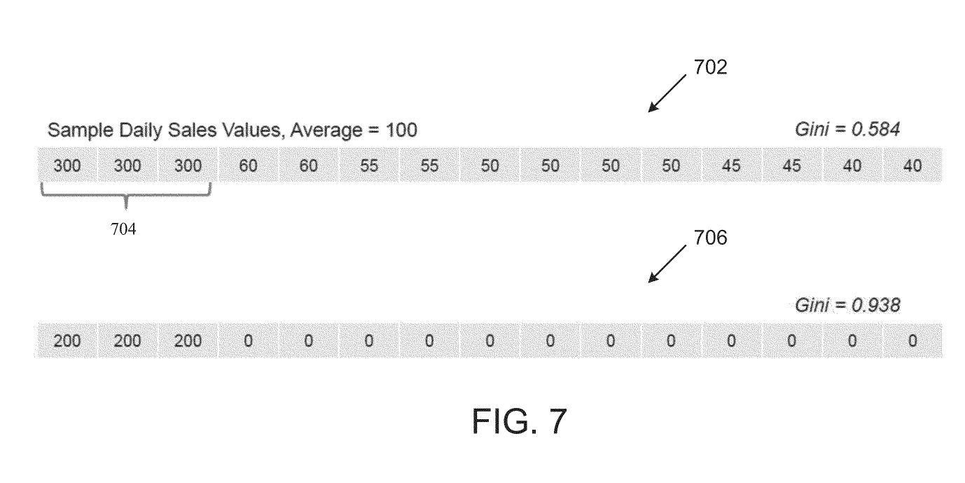

In some embodiments, the baseline average sales for a product with disproportionately dispersed sales may be so high that sales spikes may not be high enough to yield a high Gini coefficient. Therefore, to ensure better detection of such products with disproportionately dispersed sales, the sales history may be enhanced. For example, in one embodiment, the average sales value per time unit may be subtracted from every daily sales data point in the sales history to obtain an adjusted sales value for each of the daily sales data points. The calculation of the dispersion inequality value may then be carried out based on the adjusted sales values for each of the daily sales data points in the sales history. As an example, FIG. 7 depicts an adjustment of daily sales values to enhance the dispersion exhibited in a sales history according to one embodiment of the disclosure. The original unaltered daily sales history 702 yields a Gini coefficient of 0.584 even though the days within time period 704 show that the product exhibits disproportionately dispersed sales. By subtracting the average sales, which according to the embodiment of FIG. 7 is 100, for the sales history 702 from each daily sales data point and rounding to zero if the result is negative, the adjusted daily sales history 706 may be obtained. According to the embodiment of FIG. 7, the adjusted daily sales history 706 yields a Gini coefficient of 0.938, which more clearly emphasizes the unequal sales dispersion of the product.

Referring back to FIG. 4, method 400 includes, at block 404, identifying a product from the one or more products for which sales for the identified product were disproportionately dispersed over a time period. For example, in one embodiment, the Gini coefficients for multiple products at a store may be analyzed to determine whether the daily sales were disproportionately dispersed throughout the year. According to one embodiment, a threshold may be used to specify a minimum dispersion inequality value that indicates a product has sales that were disproportionately dispersed over a time period. For example, a Gini coefficient exceeding the threshold may indicate that the product associated with the Gini coefficient had sales that were disproportionately dispersed. According to one embodiment, the threshold may be user-specified, while in another embodiment the threshold may be calculated as a function of a retail metric. In addition, the threshold may be pre-defined or dynamically adjusted computationally or manually.

Gini coefficients exceeding the threshold may indicate that the products associated with the Gini coefficients exhibit JLQ-like behavior. In some embodiments, multiple products may be associated with Gini coefficients exceeding the threshold, thereby each exhibiting JLQ-like behavior, and the sales history data for each of those products may be further analyzed to optimize the inventory level for each of those products. According to one embodiment, the sales history data for a product may be further analyzed to optimize its inventory level regardless of whether the product's associated Gini coefficient exceeds the threshold. In other embodiments, the sales history data for a single product of the multiple products exhibiting JLQ-like behavior may be further analyzed to optimize the inventory level for the product. For example, the identified product at block 404 may be the product associated with the highest calculated dispersion inequality value that exceeds the threshold because it exhibits the most JLQ-like behavior.

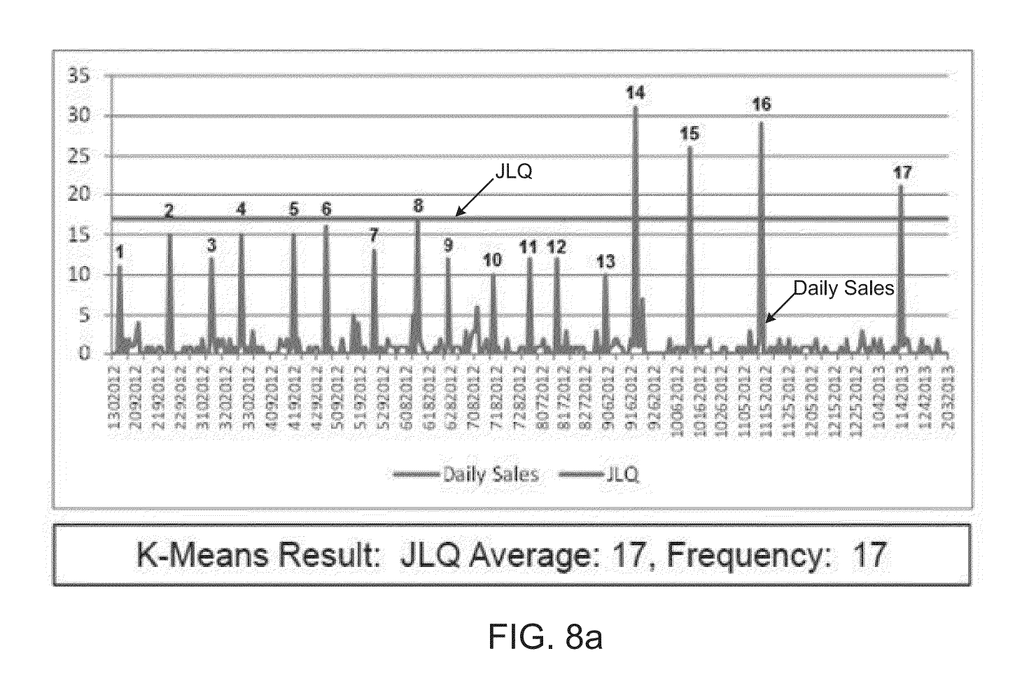

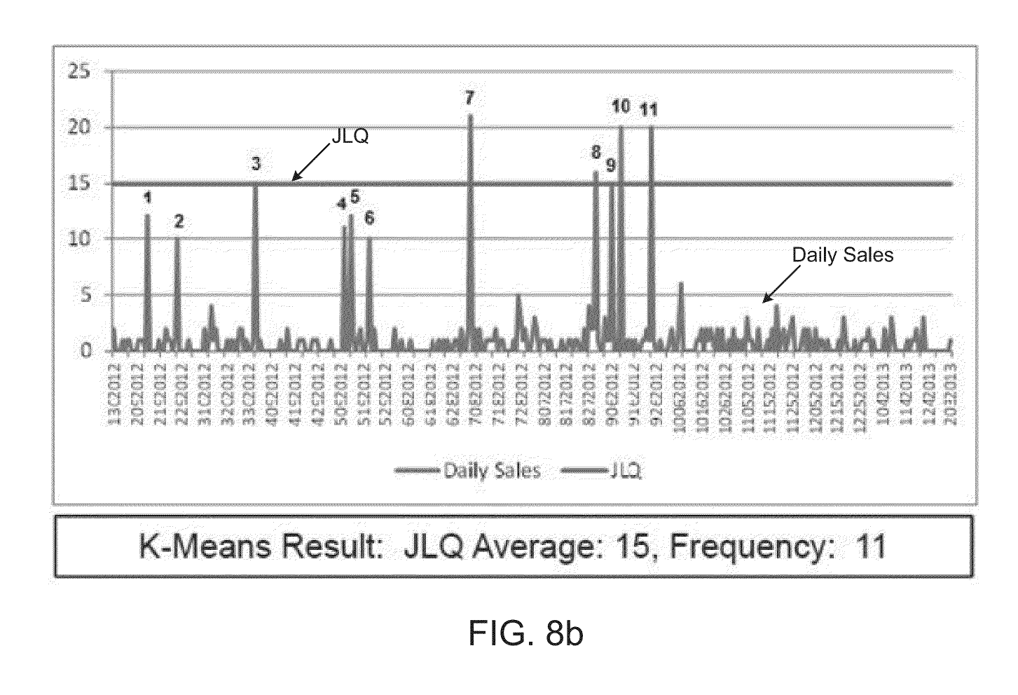

In order to determine an inventory level for a product, method 400 may further include, at block 406, determining a first quantity value and a first frequency for the identified product based, at least in part, on sales values of the product within a subset of time units of the time period. In one embodiment, determining a first quantity value and a first frequency for the identified product may include first clustering the plurality of time units into one of two clusters, wherein a mean sales value per time unit for a first cluster of time units is greater than the mean sales values per time unit for a second cluster of time units. For example, FIGS. 8a-8b depict plots illustrating the use of k-means clustering with k=2 to determine JLQ values and frequencies for different products according to one embodiment of the disclosure.

Referring to FIG. 8a, the unordered daily sales for a product are provided, and the clustering may be performed to separate the subset of daily sales that constitute a disproportionate amount of the total sales history for the product from the rest of the daily sales. According to an embodiment, initially, each data point may be assigned to the cluster with the closer mean. Subsequently, an iterative process may be performed, in which more data points may be included in one of the clusters until the total variance within each cluster is minimized. When the clustering process has completed, a first cluster may include (or mostly or completely) those daily sales on which a disproportionately high percentage of the total units were sold, and a second cluster may include the remainder of the daily sales data points. Therefore, the mean sales value per day during the first cluster may be greater than the mean sales value per day during the second cluster.

With the clusters identified, an initial JLQ value and annual frequency for the product may be determined. For example, in one embodiment, the initial JLQ value may be set to the mean sales value per day in the subset of daily sales that constitute a disproportionately high percentage of the total annual sales (i.e., the first cluster), and the annual frequency for the JLQ product may be set to the number of days in the first cluster. For example, with reference to FIG. 8a, the initial JLQ value may be 17 and the annual frequency may be 17. According to an embodiment, the subset of time units at block 406 may be the days in the first cluster, the first quantity value determined at block 406 may be the initial JLQ value for the product, and the first frequency determined at block 406 may be the determined annual frequency of the product.

FIG. 8b provides the unordered daily sales for another product. Clustering the daily sales in FIG. 8b in a similar manner as is illustrated in FIG. 8a yields an initial JLQ value of 15 for the product and an annual frequency of 11 for the product.

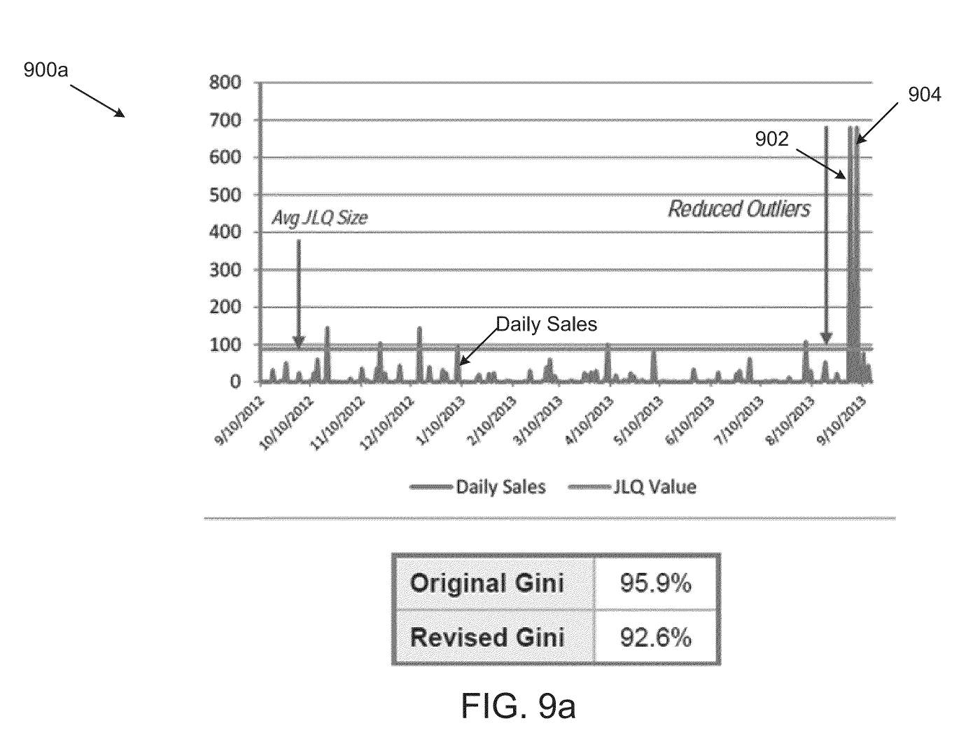

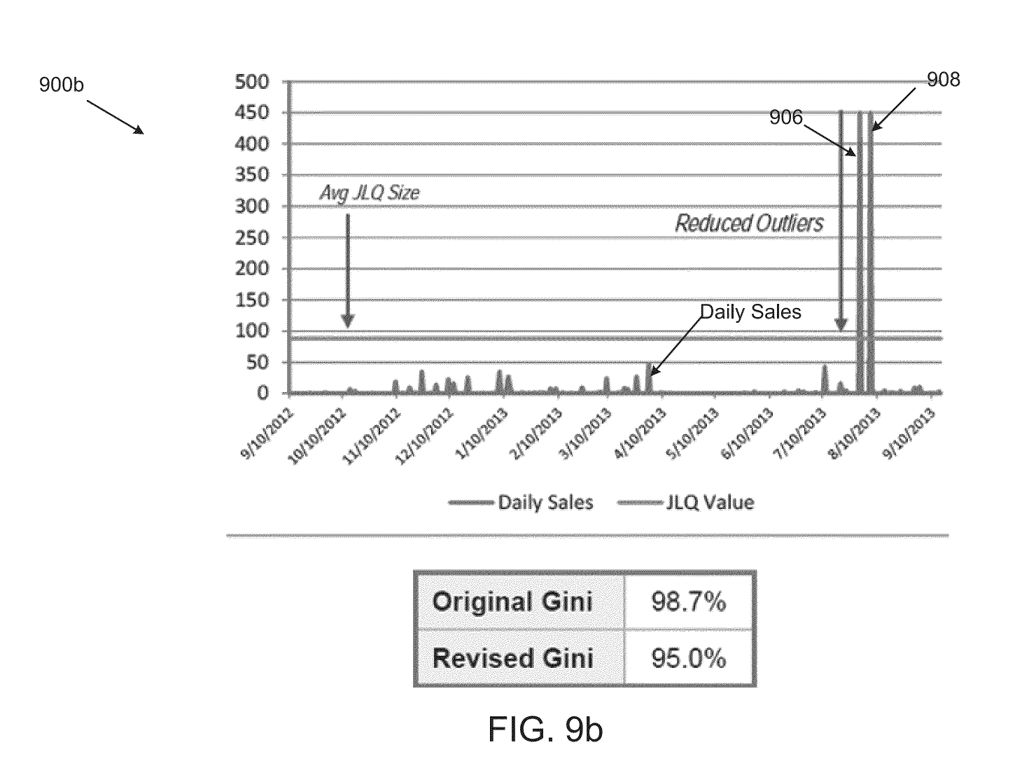

FIGS. 9a-9b depict plots illustrating the removal of outliers from sales histories according to embodiments of the disclosure. As shown in FIG. 9a, the clustering of daily sales values may result in an annual frequency for the JLQ product being significantly low, such as, for example, one or two. In order to remove the effect of these rare (or “once in a lifetime”) sales events that may be non-repeatable outlier sales, the outlier sales events 902 and 904 may be removed from the sales history of FIG. 9a and a new cluster may be calculated using k-means clustering as described above. The Gini coefficient may also be recalculated with the outlier sales events 902 and 904 being assigned sales values equal to the revised average initial JLQ value. Similar to FIG. 9a, the outlier sales events 906 and 908 in FIG. 9b may be removed from the sales history of FIG. 9b, a new cluster may be calculated using k-means clustering, and a new Gini coefficient may be recalculated with the outlier sales events 906 and 908 being assigned sales values equal to the revised average initial JLQ value. According to an embodiment, by removing the outliers as disclosed herein, the effect of the non-repeatable outlier sales on the JLQ value and the Gini score may be eliminated.

According to an embodiment, with the initial JLQ value and annual frequency for a product determined, the inventory level for a product exhibiting JLQ behavior may be determined. For example, referring back to FIG. 4, method 400 includes, at block 408, determining an inventory quantity value for the product based, at least in part, on the determined first quantity value and the determined first frequency for the product.

In some embodiments, the desired inventory level may be the inventory level for a portion of the entire time period provided in the sales history for a product. As an example, where the time period provided in the sales history for a product is a year, the portion for which the inventory level is desired may be a four-week span (one thirteenth of the full time period). In other embodiments, the portion may be the full time period. Therefore, determining the inventory may include first determining a second frequency for the product that is associated with a portion of interest of the full time period. As an example, if the annual frequency for a product is 20, and the portion of interest is 4 weeks, then the second frequency for the portion of the time period may be 1.54 (20/13). Because a product's sales may follow a seasonal pattern, in one embodiment, the first frequency may be multiplied by a seasonal factor associated with the portion of the time period (the second frequency) to obtain an adjusted first frequency. For example, considering the example above where the portion of interest is a four week time period, a seasonal factor for the portion may be 1.2, and the adjusted first frequency may therefore be 24 (20×1.2). Using the aforementioned example, because the portion of interest (the second frequency) is only the upcoming four weeks, the number of JLQ units a store associated with the example product and the example seasonal factor may need to carry may be equal to 1.85 (24/13). According to one embodiment, the seasonal factor may be user-specified, while in another embodiment the seasonal factor may be calculated as a function of one or more retail metrics. In addition, the seasonal factor may be pre-defined or dynamically-adjusted computationally or manually.

The actual inventory level (e.g., the number of JLQs that a store may need to carry) for the portion of the time period may, in some embodiments, account for a desired service level. A service level may be a percentage of sales for the product that a retailer desires to support (e.g., cover) during the portion of the time period. Based on the desired service level, another scaling factor (e.g., a service level scaling factor) may be applied to the initial JLQ value determined in order to arrive at the final inventory level.

In some embodiments, the probabilities associated with having—within the time period portion of interest—zero, one, or more time units with disproportionate sales values may be determined in order to determine an appropriate service level scaling factor. In one embodiment, such probabilities may be determined for each of multiple products based on the adjusted first frequency using a binomial distribution. As an example, and not limitation, in one embodiment the probability of x number of JLQs occurring during a time period portion of interest may be calculated using the binomial distribution P(x)=[(n!/[(n-x)!x!])* p^{x} * q^{n-x}], where x is the number of days exhibiting JLQ-like sales behavior within the time period portion of interest, n is the total number of days in the time period portion of interest, p is the probability of each day in the time period portion of interest exhibiting JLQ-like sales behavior, and q is the probability of not having a day in the time period of interest exhibit JLQ-like sales behavior. As an example of determining a probability, when the adjusted first frequency is 10, then p=0.0274 (10/365). When the time period portion of interest is 14 days, then the probability of having x=2 days exhibiting JLQ-like behavior within the 14 days may be determined to be 4.9% (P(2)=[( 14!/[(14-2)!2!])*0.0274²*0.9726¹⁴⁻²]).

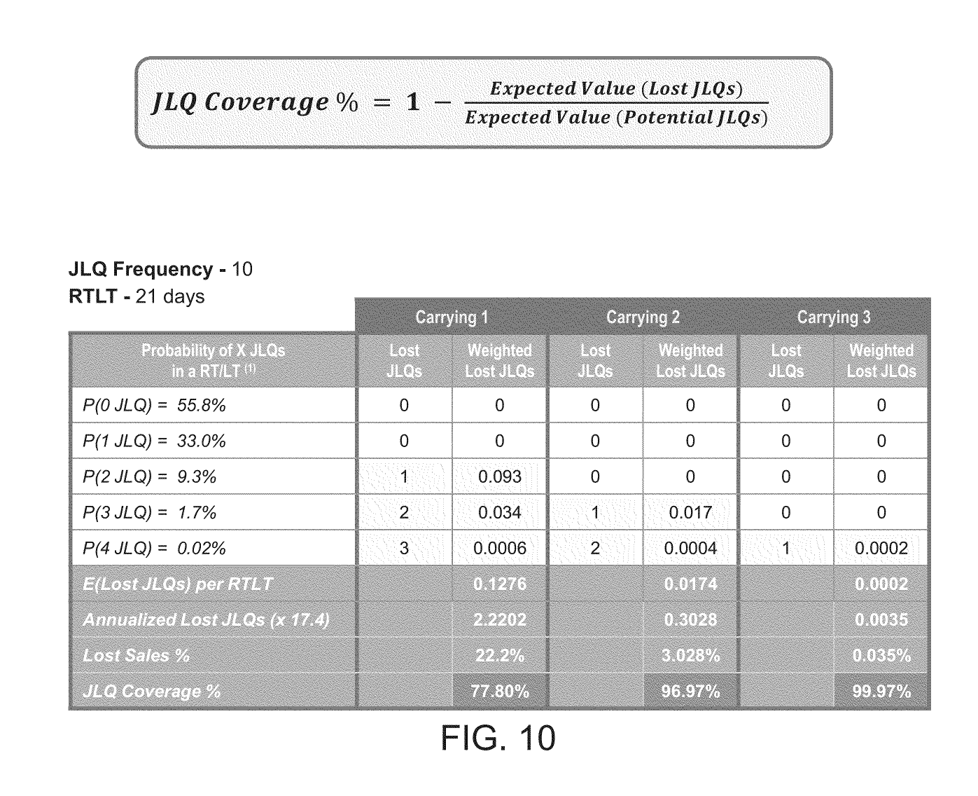

FIG. 10 depicts a table illustrating the determination of a service level percentage according to one embodiment of the disclosure. In the embodiment of FIG. 10, the adjusted JLQ frequency is 10 and the review time/lead time (RTLT) associated with the product and the store location where the product is stocked is 21 days. In some embodiments, the RTLT may also be used to specify the time period portion of interest. According to the embodiment of FIG. 10, using the binomial distribution as described above, with an adjusted JLQ frequency of 10 and a time period of interest of 21 days, the probability of having 0 days within the time period portion of interest exhibiting JLQ-like sales behavior may be determined to be 55.8%; the probability of having 1 day within the time period portion of interest exhibiting JLQ-like sales behavior may be determined to be 33%; the probability of having 2 days within the time period portion of interest exhibiting JLQ-like sales behavior may be determined to be 9.3%; the probability of having 3 days within the time period portion of interest exhibiting JLQ-like sales behavior may be determined to be 1.7%; and the probability of having 4 days within the time period portion of interest exhibiting JLQ-like sales behavior may be determined to be 0.02%. Although the probabilities associated with having only up to four days exhibiting JLQ-like sales are shown in FIG. 10, one of skill in the art will recognize that the probabilities of having more than four days with JLQ-like sales within a 21 day window may also be determined in a fashion similar to that shown in FIG. 10.

With the probabilities associated with having different numbers of days exhibiting JLQ-like sales behavior determined, the service level percentage (JLQ coverage percentage) may be determined to be equal to 1−[expected value of lost JLQs/expected value of potential JLQs]. As shown in FIG. 10, the expected value of lost JLQ-like sales days may be determined by first summing the weighted number of lost JLQ-like sales days as a function of the number of multiples of the JLQ that are in stock. For example, as shown in FIG. 10, when two multiples of the JLQ are in stock, one JLQ-like sales day will be lost if three JLQ-like sales days are expected, and two JLQ-like sales days will be lost if four JLQ-like sales days are expected. Because the probability of having three JLQ-like sales days is 1.7%, the lost JLQ-like sales day when three JLQ-like sales days are expected will be weighted by 1.7%. Similarly, because the probability of having four JLQ-like sales days is 0.02%, the two lost JLQ-like sales days when four JLQ-like sales days are expected will be weighted by 0.02%. As shown in FIG. 10, the sum of the weighted number of lost JLQ-like sales days when carrying two multiples of the JLQ in stock and accounting for the probability of having up to four JLQ-like sales days may be determined to be 0.0174. Because there are 17.4 multiples of the time period of interest in a year, the annualized number of lost JLQ-like sales days for the embodiment of FIG. 10 may be determined to be 0.303 days. With the annualized number of lost JLQ-like sales days determined, the service level percentage may be determined to be 96.97% (1−[0.303/10]=96.97%). Performing a similar analysis for the embodiments illustrated in FIG. 10 in which one multiple of the JLQ is in stock and three multiples of the JLQ are in stock results in service level percentages of 77.8% and 99.97%, respectively.

Based on the determined probabilities and a percentage of sales to support (a desired service level percentage), a service level scaling factor may be determined. For example, in some embodiments, an analysis similar to the analysis illustrated in FIG. 10 may be performed on a number of products, and the results stored in a look-up table and/or a memory device. When a particular service level percentage is desired, the number of multiples of the JLQ value may be determined by searching through the look-up table or memory to identify the number of multiples of the JLQ value that correspond to or that would allow for the desired JLQ coverage. For example, according to the embodiment of FIG. 10, for a desired service level of at least 96% for the 21 day period of interest, two multiples of the JLQ may be required to be held in stock during the time period of interest. When the desired service level does not correspond to a discrete number of multiples of the JLQ for a product, linear interpolation may be used to determine a fractional number of multiples of the JLQ to hold in stock. In some embodiments, the desired service level percentage may be user-specified, while in another embodiment the service level percentage may be calculated as a function of a retail metric. In addition, the service level percentage may be pre-defined or dynamically-adjusted computationally or manually. As shown above, the service level scaling factor may be a function of the review time/lead time associated with the product and the store location where the product is stocked. With the service level scaling factor determined, the inventory level for the product for the desired time period portion may be determined by multiplying the initial JLQ quantity by the determined service level scaling factor.

In some embodiments, the techniques or steps of the disclosed methods may be embodied directly in hardware, in software stored on non-transitory media and executable by a processor, or in a combination of the two. For example, a software module may reside in RAM memory, flash memory, ROM memory, EPROM memory, EEPROM memory, registers, hard disk, a removable disk, a CD-ROM, or any other form of non-transitory storage medium known in the art. An exemplary non-transitory storage medium may be coupled to the processor such that the processor can read data from, and write data to, the storage medium. In the alternative, the non-transitory storage medium may be integral to the processor. The processor and the storage medium may reside in an ASIC. The ASIC may reside in a user device. In the alternative, the processor and the non-transitory storage medium may reside as discrete components in a user device.

If implemented in firmware and/or software stored on non-transitory media, the functions described above may be stored as one or more instructions or code on a non-transitory computer-readable medium. Examples include non-transitory computer-readable media encoded with a data structure and non-transitory computer-readable media encoded with a computer program. Non-transitory computer-readable media includes any available medium that can be accessed by a computer. By way of example, and not limitation, such non-transitory computer-readable media can comprise RAM, ROM, EEPROM, CD-ROM or other optical disk storage, magnetic disk storage or other magnetic storage devices, or any other non-transitory medium that can be used to store desired program code in the form of instructions or data structures and that can be accessed by a computer. Disk and disc includes CDs, laser discs, optical discs, digital versatile discs (DVDs), floppy disks, and blu-ray discs. Generally, disks reproduce data magnetically, and discs reproduce data optically. Combinations of the above are also included within the scope of non-transitory computer-readable media.

The above specification and examples provide a complete description of the disclosed systems, devices, and methods and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods, devices, and systems are not intended to be limited to the particular forms disclosed. Rather, they include all modifications and alternatives falling within the scope of the claims, and embodiments other than the one shown may include some or all of the features of the depicted embodiment. For example, steps and/or modules may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A computerized method of determining an inventory quantity value for a product, the method comprising:
calculating a dispersion inequality value of sales for one or more products, wherein each of the one or more products is associated with one dispersion inequality value;
identifying a product from the one or more products for which sales for the identified product were disproportionately dispersed over a time period comprising a plurality of time units;
determining a first quantity value and a first frequency for the identified product based, at least in part, on sales values of the identified product within a subset of time units of the time period; and
determining an inventory quantity value for the identified product based, at least in part, on the determined first quantity value and the determined first frequency for the product.

2. The method of claim 1, wherein the dispersion inequality value comprises a Gini coefficient.

3. The method of claim 1, wherein the dispersion inequality value provides an indication of the unequal dispersion of sales over the time period.

4. The method of claim 1, wherein calculating the dispersion inequality value for at least one product of the one or more products comprises:
ordering the plurality of time units in ascending order according to sales values, wherein the first time unit is associated with a smallest sales value for the at least one product and the last time unit is associated with a largest sales value for the at least one product; and
calculating the dispersion inequality value based, at least in part, on the ordered plurality of time units.

5. The method of claim 4, further comprising subtracting the average sales value per time unit for the at least one product from each of the ordered plurality of time units to obtain an adjusted sales value for each of the ordered plurality of time units, wherein the calculation of the dispersion inequality value is based, at least in part, on the adjusted sales value for each of the ordered plurality of time units.

6. The method of claim 1, wherein the identified product is the product associated with the highest calculated dispersion inequality value that exceeds the threshold.

7. The method of claim 1, further comprising clustering the plurality of time units into one of two clusters, wherein a mean sales value per time unit for a first cluster of time units is greater than the mean sales value per time unit for a second cluster of time units.

8. The method of claim 7, wherein the subset of time units comprises the first cluster of time units, the first quantity value for the product comprises the mean sales value per time unit for the first cluster of time units, and the first frequency for the product comprises the number of time units in the first cluster of time units.

9. The method of claim 7, wherein clustering comprises k-means clustering, wherein k is equal to two.

10. The method of claim 1, further comprising:
determining a second frequency for the product, wherein the second frequency is a frequency associated with a portion of the time period;
multiplying the first frequency by a seasonal factor associated with the portion of the time period to obtain an adjusted first frequency;
determining a probability of having, within the portion of the time period, zero, one, or more time units with disproportionate sales values based, at least in part, on the adjusted first frequency, wherein each number of time units is associated with one probability;
determining a scaling factor based, at least in part, on the determined probabilities and a percentage of sales for the product to support; and
multiplying the first quantity value by the determined scaling factor to obtain the inventory quantity value for the product for the portion of the time period.

11. The method of claim 10, wherein the probabilities are determined using a binomial distribution.

12. The method of claim 10, wherein the time period comprises a year, the time unit comprises a day, and the portion of the time period comprises 4 weeks.

13. A system comprising:
a memory; and
a processor coupled to the memory, the processor configured to:
calculate a dispersion inequality value of sales for one or more products, wherein each of the one or more products is associated with one dispersion inequality value;
identify a product from the one or more products for which sales for the identified product were disproportionately dispersed over a time period comprising a plurality of time units;
determine a first quantity value and a first frequency for the identified product based, at least in part, on sales values of the identified product within a subset of time units of the time period; and
determine an inventory quantity value for the identified product based, at least in part, on the determined first quantity value and the determined first frequency for the product.

14. The system of claim 13, where:
the processor is further configured to:
order the plurality of time units in ascending order according to sales values, wherein the first time unit is associated with a smallest sales value for the at least one product and the last time unit is associated with a largest sales value for the at least one product; and
calculate the dispersion inequality value based, at least in part, on the ordered plurality of time units.

15. The system of claim 13, where:
the processor is further configured to:
cluster the plurality of time units into one of two clusters, wherein a mean sales value per time unit for a first cluster of time units is greater than the mean sales value per time unit for a second cluster of time units, wherein the subset of time units comprises the first cluster of time units, the first quantity value for the product comprises the mean sales value per time unit for the first cluster of time units, and the first frequency for the product comprises the number of time units in the first cluster of time units.

16. The system of claim 13, where:
the processor is further configured to: <determine a second frequency for the product, wherein the second frequency is a frequency associated with a portion of the time period;
multiply the first frequency by a seasonal factor associated with the portion of the time period to obtain an adjusted first frequency;
determine a probability of having, within the portion of the time period, zero, one, or more time units with disproportionate sales values based, at least in part, on the adjusted first frequency, wherein each number of time units is associated with one probability;
determine a scaling factor based, at least in part, on the determined probabilities and a percentage of sales for the product to support; and
multiply the first quantity value by the determined scaling factor to obtain the inventory quantity value for the product for the portion of the time period.

17. A computer program product, comprising:
a non-transitory computer-readable medium comprising code to perform the steps of:
calculating a dispersion inequality value of sales for one or more products, wherein each of the one or more products is associated with one dispersion inequality value;
identifying a product from the one or more products for which sales for the identified product were disproportionately dispersed over a time period comprising a plurality of time units;
determining a first quantity value and a first frequency for the identified product based, at least in part, on sales values of the identified product within a subset of time units of the time period; and
determining an inventory quantity value for the identified product based, at least in part, on the determined first quantity value and the determined first frequency for the product.

18. The computer program product of claim 17, wherein the medium further comprises code to perform the steps of:
order the plurality of time units in ascending order according to sales values, wherein the first time unit is associated with a smallest sales value for the at least one product and the last time unit is associated with a largest sales value for the at least one product; and
calculate the dispersion inequality value based, at least in part, on the ordered plurality of time units.

19. The computer program product of claim 17, wherein the medium further comprises code to perform the steps of:
clustering the plurality of time units into one of two clusters, wherein a mean sales value per time unit for a first cluster of time units is greater than the mean sales value per time unit for a second cluster of time units, wherein the subset of time units comprises the first cluster of time units, the first quantity value for the product comprises the mean sales value per time unit for the first cluster of time units, and the first frequency for the product comprises the number of time units in the first cluster of time units.

20. The computer program product of claim 17, wherein the medium further comprises code to perform the steps of:
determining a second frequency for the product, wherein the second frequency is a frequency associated with a portion of the time period;
multiplying the first frequency by a seasonal factor associated with the portion of the time period to obtain an adjusted first frequency;
determining a probability of having, within the portion of the time period, zero, one, or more time units with disproportionate sales values based, at least in part, on the adjusted first frequency, wherein each number of time units is associated with one probability;
determining a scaling factor based, at least in part, on the determined probabilities and a percentage of sales for the product to support; and
multiplying the first quantity value by the determined scaling factor to obtain the inventory quantity value for the product for the portion of the time period.
